(19) United States
(12) Patent Application Publication
(10) Pub. No.: US 2026/0330477 A1
(43) Pub. Date: Oct. 22, 2026

(54) BLOCKCHAIN-BASED PRODUCT AUTHENTICITY VERIFICATION SYSTEM WITH AI-ASSISTED TAMPER DETECTION

(71) Applicants: Christian Ernest Maisva, Gaborone (BW); Munamato Maiswa, Swindon (GB); Panashe Obvious Maisva, Harare (ZW); Chengeta Maisva, Coquitlam (CA); Trust Tsepo Mapoka, Gaborone (BW); Farai Tichakunda Maiswa, Pretoria (ZA); Ronald Ngara, Lithia Springs, GA (US)

(72) Inventors: Christian Ernest Maisva, Gaborone (BW); Munamato Maiswa, Swindon (GB); Panashe Obvious Maisva, Harare (ZW); Chengeta Maisva, Coquitlam (CA); Trust Tsepo Mapoka, Gaborone (BW); Farai Tichakunda Maiswa, Pretoria (ZA); Ronald Ngara, Lithia Springs, GA (US)

(21) Appl. No.: 19/368,008

(22) Filed: Oct. 24, 2025

Related U.S. Application Data
(60) Provisional application No. 63/711,178, filed on Oct. 24, 2024.

(51) Int. Cl. G06Q 30/018; G06N 3/0464; G06N 3/094; G06Q 20/06; G06Q 20/20; H04L 9/32

(52) U.S. Cl. CPC G06Q 30/0185; G06N 3/0464; G06N 3/094; G06Q 20/065; G06Q 20/208; H04L 9/3213; H04L 9/3247; G06Q 2220/00

(57) ABSTRACT

A system and method are disclosed for authenticating products using a combination of blockchain technology and artificial intelligence. The system includes a consumer mobile application and retail point-of-sale terminal configured to scan a product identifier in the form of a QR code, barcode, or NFC tag. An API gateway receives scan data and routes it to an AI tamper detection module, which analyzes image or tag characteristics to detect tampering or counterfeit activity. An authentication engine cross-verifies the scan data with product registration records stored on a blockchain ledger. The blockchain network employs smart contracts to automate product registration, ownership transfers, and authenticity validation. A notification service delivers alerts to manufacturers, retailers, and consumers in real time when tampering is detected. The system provides end-to-end product lifecycle authentication, ensuring data immutability, traceability, and transparency throughout the supply chain, thereby mitigating counterfeit risks and enabling secure verification of product integrity.

### CROSS REFERENCE TO RELATED APPLICATIONS

This patent application claims the benefit of United States Provisional Patent Application No. 63/711,178 filed on Oct. 24, 2024.

### FIELD OF THE INVENTION

The present invention relates to the field of product authentication and counterfeit prevention. More particularly, it pertains to a system and method that integrates blockchain technology with artificial intelligence (AI) to verify product authenticity, detect tampering, and enable real-time tracking of goods throughout the supply chain. The invention provides an immutable, transparent, and intelligent authentication framework that ensures the integrity of products from manufacturing to final sale, applicable across diverse industries such as pharmaceuticals, luxury goods, electronics, and consumer products.

### BACKGROUND OF THE INVENTION

Product counterfeiting has become a widespread and growing problem across many industries, affecting everything from pharmaceuticals, luxury goods, and electronics to everyday consumer products. The impact of counterfeit goods is profound, leading to significant financial losses for manufacturers, harm to brand reputations, and, in some cases, posing severe risks to consumer safety, especially in sectors like pharmaceuticals and electronics. Traditional methods of product authentication, such as using static barcodes, holograms, or serial numbers, have proven inadequate in combating increasingly sophisticated counterfeiting techniques. These conventional methods often lack real-time tracking capabilities and can be easily duplicated or tampered with, offering minimal protection for consumers or businesses.

Additionally, supply chains have become more complex and global, with products passing through multiple intermediaries before reaching the end consumer. This complexity introduces more opportunities for counterfeit products to infiltrate legitimate supply chains, making it difficult for manufacturers, retailers, and consumers to verify the authenticity of a product. Existing systems often rely on centralized databases or manual verification methods, both of which are prone to errors, fraud, and manipulation.

The traditional systems like barcodes or RFID tags do not provide an immutable or tamper-proof method to track products throughout their lifecycle. Once a product leaves the manufacturer, it becomes difficult to ensure its authenticity as it moves through various distribution channels. The conventional methods such as holograms, labels, or serial numbers can be easily duplicated by counterfeiters, making it hard for retailers and consumers to distinguish between genuine and fake products. Current authentication systems typically do not allow real-time verification by end consumers. Verification is often done at select points within the supply chain, leaving opportunities for counterfeit products to pass undetected. The consumers have little to no access to the verification process, limiting their ability to confirm whether a product is authentic or has been tampered with after purchase. There is a lack of effective tampering detection mechanisms in existing systems. Counterfeiters can open and repackage products without leaving obvious signs of tampering, making it challenging to detect counterfeit goods post-production.

To address these shortcomings, various technological approaches have been explored in the art. One well-known category involves blockchain-based product authentication systems that utilize immutable distributed ledgers to store product lifecycle data. For example, U.S. Patent Application Publication No. US 2021/026444 A1, titled “Blockchain-Based Product Authentication System,” discloses using blockchain records linked to QR codes for verifying product authenticity. Similarly, U.S. Patent Application Publication No. US 2017/0262862 A1 and U.S. Pat. No. 11,329,804 B2 assigned to Honeywell describe blockchain-enabled provenance tracking for parts and products using serial identifiers and secure tagging. These systems improved transparency and record immutability but generally relied on static codes and lacked sophisticated tampering detection or post-sale protection.

Other prior-art systems—such as US 2022/0215382 A1—focus on blockchain-based authentication combined with scannable identifiers like RFID or NFC tags. While such systems enable decentralized verification and traceability, they often depend solely on ledger updates without incorporating any intelligent tamper-detection mechanism. As a result, once a counterfeit tag replicates a valid identifier, the blockchain entry may still appear authentic, leaving gaps in security.

In parallel, researchers have investigated AI-driven image-based counterfeit detection methods. For instance, WO 2018/178822 A1 discloses using image analysis techniques to compare a product's visual features with reference images to detect deviations indicative of counterfeit goods. Likewise, US 2019/0236614 A1 presents the use of machine-learning and deep-neural-network (DNN) algorithms to classify authentic and counterfeit product images. These prior approaches introduced automation in tamper detection; however, they operate independently of blockchain systems and do not maintain a verifiable audit trail of authentication events.

Some more recent developments, such as U.S. Application No. 2025/0285126 (“Encoding an NFC Tag for Product Authentication”), combine NFC technology with blockchain ledgers to record immutable tap transactions for each product. While this represents progress toward traceable NFC authentication, these systems still lack AI-based anomaly detection and typically do not provide dynamic tag deactivation or lifecycle closure at the point of sale.

Additionally, point-of-sale (POS) tag deactivation systems have been described in patents like U.S. Pat. No. 11,030,870 B2 and CN 100570655 C, which disclose methods of deactivating security or electronic article surveillance (EAS) tags once a product is sold. Although these inventions prevent reuse of security tags, they are not integrated with blockchain or AI, and therefore fail to provide tamper-proof supply-chain authentication or counterfeit pattern analysis.

Beyond patent literature, several industrial and academic implementations have explored using blockchain with QR or NFC technologies for anti-counterfeiting purposes. Projects by companies such as Alibaba and academic works like “QR-Based Fake Product Detection Using Blockchain” (ResearchGate, 2024) demonstrate real-world prototypes linking dynamic QR codes to blockchain ledgers for authenticity checks. However, these solutions primarily focus on recording provenance and single-use code validation, without incorporating AI for image-based tampering detection or scan-pattern intelligence.

Despite these advancements, existing systems still exhibit critical limitations. Most prior-art solutions focus on either blockchain-based provenance tracking or AI-based counterfeit detection, but not both in an integrated manner. They often rely on static identifiers that can be copied, lack real-time anomaly detection, and provide limited visibility to end-consumers. Moreover, post-sale product handling remains unsecured; counterfeiters can reuse identifiers or reintroduce items into circulation after purchase, as traditional systems do not mark items as permanently sold on an immutable ledger.

There remains a need for a comprehensive, intelligent, and tamper-proof product authentication system that integrates the immutable security of blockchain with the analytical capabilities of AI. Such a system should (i) assign each product a dynamic, non-replicable identifier linked to a decentralized ledger, (ii) enable real-time tracking and status updates throughout the supply chain, (iii) employ AI algorithms to detect tampering through image analysis and scanning-pattern recognition, and (iv) automatically deactivate or mark products as “Sold” upon completion of sale, thereby closing the authentication loop. Furthermore, it should empower consumers to independently verify authenticity and transparency through a mobile interface.

Existing blockchain-based solutions (e.g., US 2021/026444 A1, US 2017/0262862 A1) lack integrated AI for detecting counterfeit anomalies. AI-driven approaches (e.g., WO 2018/178822 A1, US 2019/0236614 A1) do not maintain immutable audit trails of authentication events. NFC and POS-based solutions (e.g., US 2025/0285126, U.S. Pat. No. 11,030,870 B2) fail to combine real-time blockchain verification with AI-powered tampering detection. Hence, none of the prior systems provide a unified framework that ensures immutable provenance, intelligent tampering detection, dynamic code lifecycle management, and post-sale deactivation, all accessible through a consumer-friendly verification platform.

Accordingly, the present invention aims to overcome the limitations of prior systems by providing an integrated blockchain and AI-based authentication ecosystem that ensures real-time, end-to-end product integrity. It introduces novel features such as AI-based scan-pattern anomaly detection, dynamic QR/NFC tags linked to blockchain, and POS-based automatic deactivation of identifiers, thus offering a holistic and intelligent solution for combating counterfeiting and enhancing supply-chain transparency.

### SUMMARY OF THE INVENTION

The invention titled “System and Method for Product Authentication Using Blockchain and AI” provides an innovative solution to the global problem of product counterfeiting by leveraging a combination of blockchain technology and artificial intelligence (AI). It offers a comprehensive framework for authenticating products, ensuring their integrity, and preventing tampering from the point of manufacturing through the entire supply chain to the final consumer. The system enhances transparency, security, and real-time verification capabilities, addressing the shortcomings of traditional authentication methods.

The invention introduces a system where products are assigned unique identifiers that are linked to a blockchain ledger, creating an immutable and tamper-proof record of each product's journey from the point of manufacture to final sale. Additionally, AI-powered modules are used to analyze product scans and detect tampering, further enhancing the system's robustness against counterfeit activities. By using scannable tags such as dynamic QR codes or NFC tags, both retailers and consumers can verify the authenticity of products in real-time using a mobile application.

In an embodiment of the present invention, the system utilizes a decentralized blockchain ledger to store immutable records of a product's lifecycle. This ledger contains key product information such as manufacturing details, shipment, distribution, and final sale status. Once a product's information is entered into the blockchain, it cannot be altered or tampered with, ensuring the authenticity and integrity of the product throughout its journey in the supply chain. Each product is assigned a dynamic QR code or NFC tag that is linked to the blockchain. This scannable tag contains a unique identifier that can be scanned by retailers, distributors, or consumers to access the product's current status in the blockchain. Each interaction (e.g., scanning at different points in the supply chain) updates the product's status in real-time, ensuring complete visibility and transparency.

One of the core innovations of this invention is the use of AI algorithms to detect tampering and counterfeit activities. The AI module analyzes data such as scanning patterns (e.g., multiple scans from geographically distant locations) and product images. By comparing scanned images to reference images stored on the blockchain, the AI can identify signs of tampering, inconsistencies, or alterations that may indicate counterfeit activity.

At the Point of Sale (POS), the system automatically updates the product's status on the blockchain to reflect that the product has been “Sold.” Once marked as sold, the product's QR code or NFC tag becomes inactive for future verifications, preventing it from being resold as new. This feature also ensures that products cannot be tampered with or resold after purchase.

The system includes a mobile application that allows consumers and retailers to scan the product's QR code or NFC tag and verify its authenticity in real-time. The application pulls data from the blockchain ledger to provide detailed information about the product's history, status, and any potential tampering detected by the AI module. Consumers are empowered to ensure they are purchasing genuine, untampered products.

In an embodiment of the present invention, the system is configured to offer a tamper-proof method of authentication by using dynamic tags linked to an immutable blockchain, making it extremely difficult for counterfeiters to create fake products that can pass the system's verification process. The invention ensures end-to-end visibility of the product's journey, allowing each checkpoint in the supply chain to be recorded on the blockchain and verified by consumers at any stage. The AI-powered tampering detection in this invention provides a sophisticated layer of protection by analyzing product scans and images to identify any signs of tampering or discrepancies with the original reference. This system empowers consumers by providing them with a mobile application that allows them to independently verify the authenticity and integrity of the products they purchase in real-time, fostering greater trust and transparency. The invention's integration with the POS system ensures that once a product is sold, it is marked as “Sold” on the blockchain, preventing it from being resold as a new product and deterring post-purchase fraud.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE ACCOMPANYING DRAWINGS

The aforesaid as well as other objects and advantages of the invention will appear hereinafter from the following description taken in connection with the accompanying drawings in which:

FIG. 1A and FIG. 1B illustrates a schematic overview showing all major components and their interconnections;

FIG. 2 illustrates the functional diagram of the AI-Based Tamper Detection System;

FIG. 3 illustrates data model representing Product Lifecycle Entry on the Blockchain; and

FIG. 4 illustrates flowchart showing End-to-End Product Lifecycle Authentication Process;

### DETAILED DESCRIPTION OF THE INVENTION

Additional features and advantages of the invention will be set forth in the description which follows, and in part will be obvious from the description, or may be learned by the practice of the invention. These and other features of the present invention will become more fully apparent from the following description, or may be learned by the practice of the invention as set forth hereinafter.

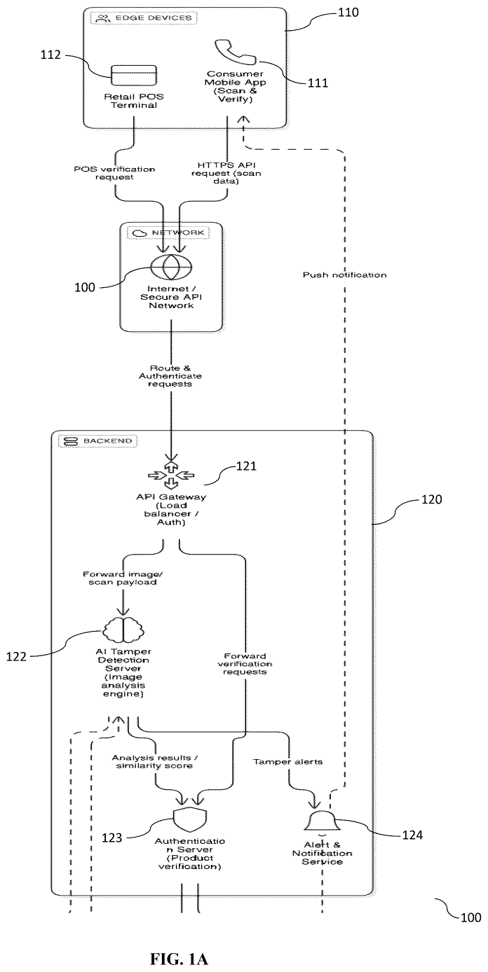

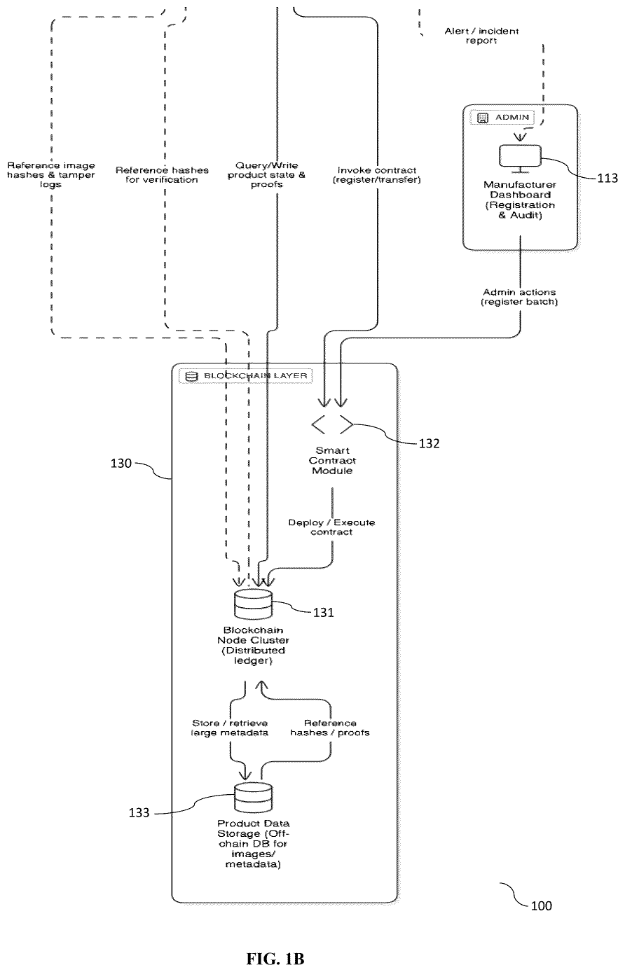

With reference now to the drawings, and in particular from FIG. 1 to FIG. 4 thereof, a system and method for product authentication using blockchain and artificial intelligence embodying the principles and concepts of the present invention is described.

FIG. 1 illustrates a schematic diagram of a system architecture (100) wherein the system comprises an integrated network of hardware and software components that collectively ensure the authenticity, traceability, and tamper-resistance of physical or digital products throughout their life cycle. The architecture utilizes a multi-layered design, including a User Layer, an Application Processing Layer, and a Blockchain and Data Layer, all interconnected through secure communication channels and data exchange protocols.

At the top level, the User Layer (110) comprises multiple access points that allow different stakeholders to interact with the system. This layer includes a Consumer Mobile Application (111), a Retail Point-of-Sale (POS) Terminal (112), and a Manufacturer Dashboard (113). Each component serves a unique functional role within the authentication ecosystem.

The Consumer Mobile Application (111) enables end-users to verify the authenticity of a product by scanning a dynamic QR code or NFC tag affixed to the product packaging. Upon scanning, the mobile application communicates with the backend infrastructure via an API to retrieve the product's authenticity status and tamper analysis result. The mobile interface provides real-time feedback to the user, displaying whether the product is genuine, suspicious, or previously authenticated.

At the top level, the User Layer (110) comprises multiple access points that allow different stakeholders to interact with the system. This layer includes a Consumer Mobile Application (111), a Retail Point-of-Sale (POS) Terminal (112), and a Manufacturer Dashboard (113). Each component serves a unique functional role within the authentication ecosystem.

The Consumer Mobile Application (111) enables end-users to verify the authenticity of a product by scanning a dynamic QR code or NFC tag affixed to the product packaging. Upon scanning, the mobile application communicates with the backend infrastructure via an API to retrieve the product's authenticity status and tamper analysis result. The mobile interface provides real-time feedback to the user, displaying whether the product is genuine, suspicious, or previously authenticated.

The Retail POS Terminal (112) serves as an intermediate authentication checkpoint. When a product is purchased, the POS system validates its authenticity against blockchain-stored records before finalizing the transaction. The POS terminal also logs the sale event to ensure that the same product identifier cannot be reused or resold fraudulently in another transaction. This process effectively prevents gray-market diversion and resale of counterfeit goods.

The Manufacturer Dashboard (113) provides administrative control and reporting capabilities. Manufacturers use this interface to register new products, associate unique digital identifiers (e.g., QR codes, NFC tags), and monitor tamper alerts or verification statistics across their product lines. Through this dashboard, authorized personnel can access analytics reports, view transaction histories, and initiate ownership transfers via integrated smart contracts.

The Application Processing Layer (120) forms the core of the system's logic and computation framework. It comprises several functional modules—namely, the API Gateway (121), AI Tamper Detection Module (122), Authentication Engine (123), and Alert and Notification Service (124)—which operate in a sequential and cooperative manner.

The API Gateway (121) functions as a secure interface for managing all inbound and outbound requests from the user layer. It ensures load balancing, request validation, and authorization of client devices such as mobile applications and POS terminals. The gateway routes each authentication request to the appropriate backend service based on its function—whether for tamper analysis, blockchain verification, or data retrieval.

The AI Tamper Detection Module (122) plays a crucial role in verifying the physical integrity of the product's visual identifiers. It receives image data captured from the consumer or POS terminal during the scan process and compares it against reference image templates stored on the blockchain. Using machine learning algorithms, the module analyzes attributes such as texture consistency, edge patterns, and printing anomalies to determine if the product's tag or packaging has been tampered with, altered, or duplicated. Detected anomalies are logged and assigned a confidence score for further action.

The Authentication Engine (123) acts as the decision-making entity of the system. It cross-references the tamper analysis data with blockchain-stored product records to determine the final authenticity status. The engine verifies multiple parameters such as unique identifier validity, registration timestamp, and ownership state. If the record is verified as legitimate and the tamper score is below a predefined threshold, the product is declared authentic; otherwise, it is flagged for review or rejection.

The Alert and Notification Service (124) manages system-wide communications and incident reporting. When the AI Tamper Detection Module identifies an irregularity, this service automatically triggers notifications to relevant stakeholders, including the manufacturer, distributor, and end-user. Alerts may include tamper images, product IDs, and anomaly scores, enabling swift action such as blocking distribution, investigating fraud, or initiating recall procedures.

The Blockchain and Data Layer (130) provides the immutable and decentralized foundation upon which the entire system operates. It includes a Blockchain Network (131), a Smart Contract Module (132), and a Product Data Storage (133) for off-chain data management.

The Blockchain Network (131) functions as a distributed ledger system that records all product registration, ownership transfer, and authentication events in a tamper-proof manner. Each product scan or verification instance generates a new transaction block that is cryptographically linked to its predecessor, ensuring complete transparency and traceability throughout the supply chain.

The Smart Contract Module (132) contains predefined logic for automating critical functions such as product registration, authenticity validation, and post-sale ownership transfer. For example, when a manufacturer registers a new product, the smart contract automatically generates a blockchain entry linking the product's identifier, batch details, and manufacturing timestamp. Similarly, upon product verification at a POS terminal, a smart contract can mark the product as “sold,” preventing any future fraudulent claims.

The Product Data Storage (133) represents an off-chain repository used to store high-volume or non-transactional data such as product images, AI training datasets, and tamper reference patterns. While the blockchain maintains hashed references for verification integrity, the actual multimedia and analytical data are stored in secure off-chain databases to optimize system performance and scalability.

During a typical operation, a user scans a product tag via the mobile application, which transmits the data to the API Gateway (121). The AI Tamper Detection Module (122) processes the visual input and forwards analysis results to the Authentication Engine (123). The Authentication Engine then queries the Blockchain Network (131) to confirm the legitimacy of the product record. Depending on the verification outcome, the Alert and Notification Service (124) communicates the status to the end-user and manufacturer in real-time. Each event is immutably logged on the blockchain, ensuring transparency and non-repudiation.

The architecture shown in FIG. 1 ensures end-to-end product verification by combining the strengths of AI-driven image analysis and blockchain-based record immutability. The layered design improves modularity, enabling each component to operate independently yet cohesively within the authentication framework. Additionally, the system's architecture supports scalability across diverse industries, including pharmaceuticals, electronics, luxury goods, and consumer products. Its decentralized and intelligent framework provides enhanced counterfeit resistance, real-time fraud detection, and consumer trust through transparent verification.

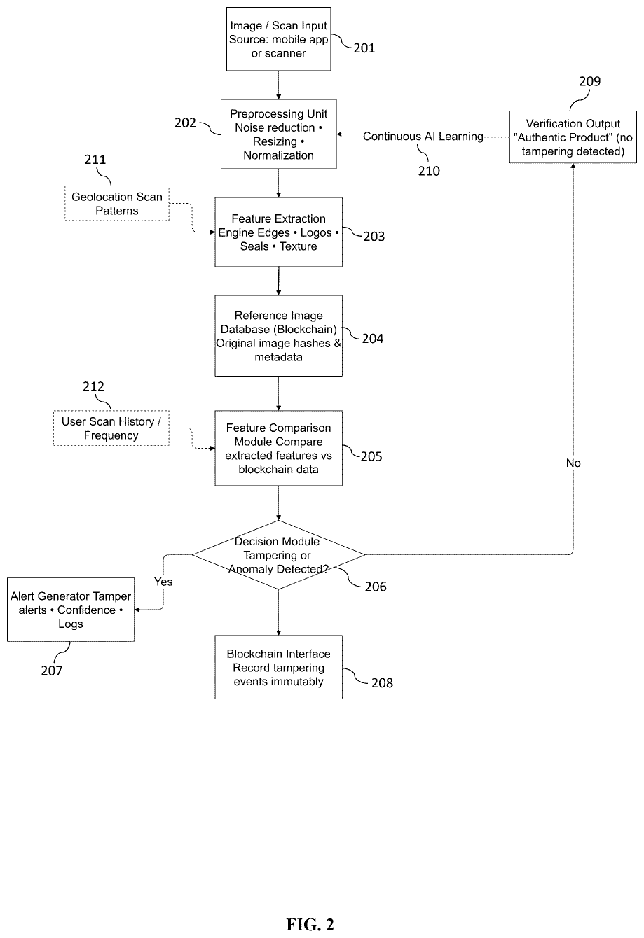

FIG. 2 illustrates a functional block diagram of an AI-Based Tamper Detection Module (200) that forms a core component of the authentication system described in FIG. 1. The module leverages artificial intelligence (AI) and computer vision techniques to analyze product tags, packaging, or embedded images to detect any signs of tampering, duplication, or counterfeit replication. The system integrates multiple submodules arranged sequentially to ensure accurate detection, adaptive learning, and secure data validation with blockchain linkage.

The module begins its operation with an Image/Scan Input unit (201), which receives visual data of the product from external sources such as the consumer mobile application or retail POS terminal. The captured image may include a QR code, NFC tag, holographic label, or any visual authentication mark affixed to the product's surface. The input unit standardizes the received image format and prepares it for further analysis.

The image data is then transferred to the Preprocessing Unit (202). This unit performs a series of enhancement and normalization operations, including noise reduction, grayscale conversion, image resizing, and contrast adjustment. These processes ensure consistency and remove visual distortions that may arise due to lighting variations, camera angle differences, or environmental interference during the scan. The output from this stage is a uniform, optimized image suitable for AI-based feature analysis.

Following preprocessing, the data is forwarded to the Feature Extraction Engine (203). This module employs convolutional neural networks (CNNs) and deep image processing algorithms to identify distinct visual markers such as logo contours, texture consistency, pattern alignment, and microprint details. The extracted features are transformed into a digital signature or hash that represents the unique visual fingerprint of the scanned product.

The Feature Extraction Engine (203) interfaces with a Reference Image Database (204), which contains authenticated image records and visual signatures of verified products. These reference images or hashes are either stored directly on the blockchain or linked through hashed entries in an off-chain database. The engine compares the live extracted features against the stored reference data to identify deviations, inconsistencies, or unauthorized duplications that could indicate tampering or counterfeit attempts.

Optionally, the module can also consider contextual factors such as geolocation data or user scan frequency patterns to reinforce the reliability of the authenticity check. For instance, if multiple scans occur in geographically disparate locations within a short time frame, the system can assign a higher suspicion score to the product's authenticity status.

The comparison results are passed to the Feature Comparison Module (205). This module quantifies the degree of similarity between the scanned product's feature vector and its blockchain-registered reference vector. Using statistical and AI-based confidence metrics, the system computes a tamper score that indicates the probability of visual alteration. Deviations exceeding a predetermined threshold are flagged as potential tampering incidents.

The Decision Unit (206), represented as a decision diamond in FIG. 2, evaluates the computed tamper score to determine whether tampering or anomalies have been detected. If the score surpasses the set confidence threshold, the system classifies the product as “tampered” or “suspect.” Conversely, if the score remains within acceptable limits, the system validates the product as authentic and proceeds to generate verification data for display to the user.

If tampering is detected, the decision output triggers the Alert Generator (207). This submodule creates a detailed tamper incident record containing key information such as product ID, timestamp, tamper confidence score, and captured image evidence. The Alert Generator forwards this information to the Alert and Notification Service (described in FIG. 1) for further dissemination to the manufacturer, supply chain operator, and end-user.

Simultaneously, the system interacts with a Blockchain Interface (208) to immutably log the tamper detection event. This ensures that every instance of anomaly detection is stored as a verifiable record within the blockchain ledger, providing traceability and auditability across the product's lifecycle. The blockchain entry includes the tamper report hash, feature comparison summary, and model reference version for forensic validation.

If no tampering is detected, the Decision Unit (206) outputs a positive verification message to the Verification Output unit (209). This unit communicates the “Authentic Product” result to the user interface along with a confidence score and optional blockchain transaction reference. This real-time feedback loop enhances user confidence and transparency in the verification process.

To improve model accuracy over time, the module incorporates a Feedback Loop (210) that connects back to the Preprocessing and Feature Extraction stages. This loop enables continuous learning, allowing the AI model to adapt to new counterfeit methods and environmental changes. Verified scan data and confirmed tamper incidents are periodically used to retrain the AI model, ensuring sustained accuracy and system evolution.

The AI-Based Tamper Detection Module (200) may also integrate external data sources, such as Geolocation Scan Patterns (211) and User Scan History (212). These auxiliary data streams enhance the intelligence of the decision-making process by providing environmental and behavioral context. For example, multiple scans from the same user device at consistent locations can reinforce authenticity, while scattered scan activity from unrelated devices can indicate possible misuse or cloning of product identifiers.

The AI-Based Tamper Detection Module (200) significantly enhances the integrity and reliability of product authentication systems by providing a self-learning, image-driven security layer. Unlike traditional verification systems that rely solely on static identifiers, this AI module dynamically analyzes visual, contextual, and behavioral data to detect fraudulent activity. Its integration with blockchain ensures that all analytical outputs and tamper incidents are securely recorded, offering immutable evidence trails for manufacturers and consumers alike.

Through this architecture, the system provides real-time fraud detection, adaptive learning, and cross-platform interoperability, enabling scalability across multiple industries including pharmaceuticals, electronics, consumer goods, and luxury items. The AI module's modular design allows independent upgrades, retraining, and deployment without disrupting the broader authentication ecosystem.

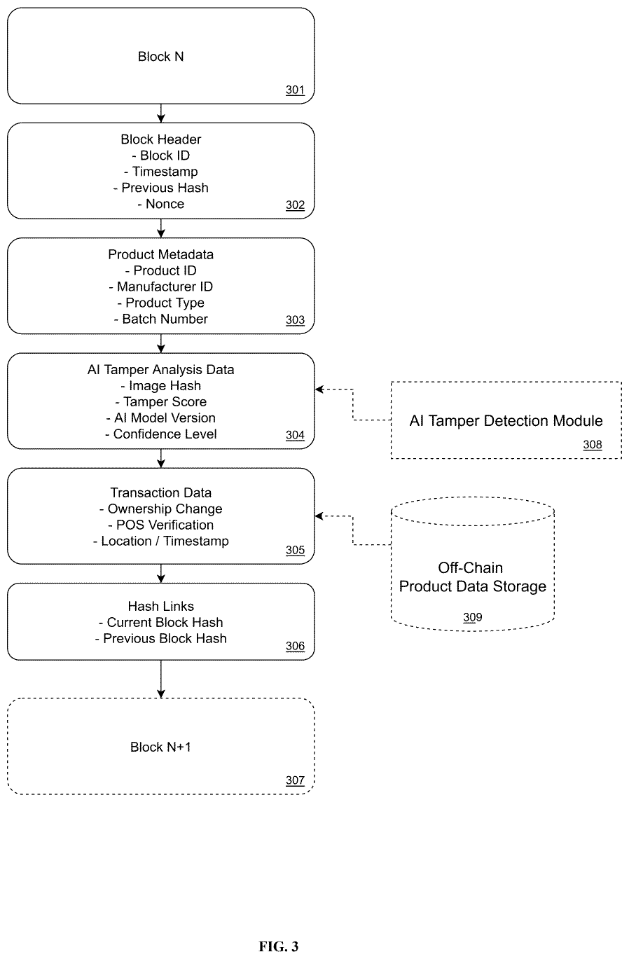

FIG. 3 illustrates a schematic representation of the Blockchain Record Structure (300) employed in the system for product authentication and tamper verification. The blockchain record structure defines the data schema, transaction relationships, and linkages that ensure the immutability and traceability of every product-related event. Each block in the blockchain contains both transactional and analytical data, forming a chronological chain of trust that prevents unauthorized alteration or duplication of product information.

As shown in FIG. 3, each blockchain entry is represented as a Block (301) that forms part of a sequentially linked distributed ledger. Every block stores a combination of product metadata, AI tamper analysis results, transaction records, and cryptographic linkages. The blocks are arranged such that each new entry references the hash of its predecessor, maintaining an unbroken and tamper-proof history of product verification events.

The upper section of each block contains a Block Header (302), which includes essential blockchain control parameters such as the Block ID, Timestamp, Previous Hash, and Nonce. The Block ID uniquely identifies the block within the ledger, while the timestamp records the precise moment the data entry was created. The previous hash parameter stores the cryptographic hash of the preceding block, thereby establishing the chain linkage. The nonce serves as a variable used in consensus mechanisms such as Proof-of-Work or Proof-of-Authority, depending on the network design. Together, these parameters ensure chronological order, authenticity, and resistance to data tampering.

Beneath the header section lies the Product Metadata Field (303). This field contains essential information regarding the registered product, including Product ID, Manufacturer ID, Product Type, Batch Number, and optionally, Production Date and Origin Details. Each of these attributes is encoded and hashed before being committed to the blockchain, ensuring that sensitive business or manufacturing information remains private while maintaining verifiability. The metadata forms the foundational record for every product instance tracked in the system.

The next section of the block structure comprises the AI Tamper Analysis Data Field (304). This component stores analytical results generated by the AI-Based Tamper Detection Module described in FIG. 2. It includes parameters such as Image Hash, Tamper Confidence Score, AI Model Version, Anomaly Detection Type, and Verification Outcome. These data points represent the digital evidence associated with each authentication event. By storing this analytical data on the blockchain, the system ensures a permanent, verifiable record of tamper evaluations that cannot be altered or falsified.

Following the AI analysis field is the Transaction Data Field (305). This section contains information about product ownership, sale, and verification activities. Typical entries include Transaction ID, Ownership Transfer Details, POS Verification Timestamp, Location Coordinates, and Actor Signatures (e.g., retailer, distributor, or manufacturer). When a product changes hands —such as from manufacturer to distributor or from retailer to consumer—a new transaction record is appended, enabling transparent supply chain traceability.

At the lower portion of the block resides the Hash Links Field (306), which contains both the Current Block Hash and the Previous Block Hash. These hash values are cryptographically generated by combining the data of all preceding sections—header, metadata, analysis, and transaction fields. This chaining mechanism guarantees data immutability; any alteration in a prior block would disrupt the hash continuity and be immediately detected by the network. The sequential structure ensures permanent traceability across the blockchain, providing a forensic audit trail for every authenticated product.

Each block, such as Block N (301), is directly linked to the subsequent Block N+1 (307), forming a continuous distributed ledger. This linkage preserves the chronological order of product events, from initial registration to final sale and post-sale verification. When new authentication events occur—such as AI-based tamper detections or consumer scan verifications—corresponding entries are generated as new blocks and appended to the chain, ensuring real-time transparency and continuous data integrity.

The blockchain record structure also supports connectivity with external modules through controlled APIs and cryptographic references. As shown in FIG. 3, the AI Tamper Detection Module (308) interfaces with the blockchain via hashed image and analysis reports, allowing tamper data to be recorded immutably without storing large image files directly on-chain. Similarly, the Off-chain Product Data Storage (309) serves as a complementary repository that houses extensive multimedia data, training datasets, and metadata not suitable for on-chain storage. Each off-chain record is referenced in the blockchain through a hash pointer, ensuring both scalability and verifiable integrity.

Collectively, the blockchain record structure (300) ensures that every authentication event —whether AI-generated or user-initiated—is recorded in an immutable, time-stamped, and cryptographically secured manner. The system's decentralized design eliminates the possibility of unilateral manipulation by any participant. Manufacturers, consumers, and regulatory authorities can independently verify the authenticity of a product by referencing blockchain records, thereby reinforcing transparency and accountability across the supply chain.

The blockchain record structure described in FIG. 3 provides multiple operational and security benefits. By embedding AI analysis results within the blockchain, the system establishes a verifiable link between physical product evidence and digital authentication data. This integration allows for instant verification, traceability, and forensic auditability of every transaction. Furthermore, by separating heavy data storage to an off-chain environment, the architecture maintains high performance and cost-efficiency while still ensuring cryptographic integrity through hash references. The resulting structure forms a trustworthy digital ledger that underpins the entire AI-driven authentication ecosystem.

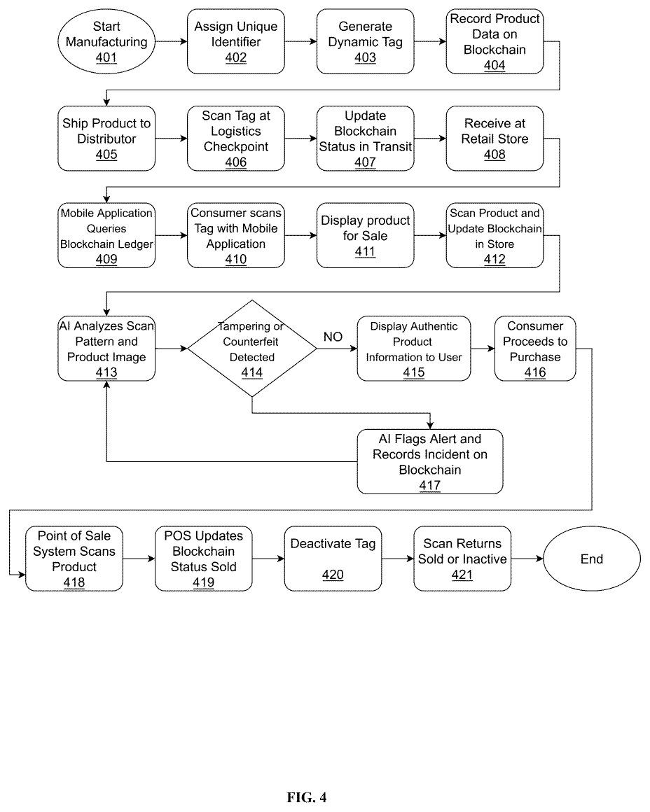

FIG. 4 illustrates a flowchart (400) representing the end-to-end lifecycle of product authentication using the system and method for product authentication with blockchain and artificial intelligence (AI). The flowchart outlines the sequence of events beginning from product manufacturing through blockchain registration, supply chain tracking, AI-based tamper analysis, retail verification, and post-sale lifecycle closure. The process ensures that each stage in the product's journey is cryptographically verifiable, tamper-resistant, and digitally recorded on a distributed blockchain ledger.

At Step 401, the process begins with Start Manufacturing, wherein a product is fabricated or assembled by the manufacturer. Upon completion of physical production, the product is prepared for digital identification and registration in the authentication system.

At Step 402, the system executes Assign Unique Identifier, in which each product is assigned a unique alphanumeric or cryptographic identifier. This identifier may be encoded into a QR code, barcode, RFID, or NFC tag, physically affixed to the product packaging or embedded within the product label. The identifier serves as the digital fingerprint of the product across the entire supply chain.

At Step 403, the system performs Generate Dynamic Tag, where a dynamic digital tag is generated. The tag may include encrypted metadata such as manufacturing batch number, production date, or origin data. Dynamic tag generation ensures that even identical product models carry distinct identifiers, enhancing traceability and preventing duplication.

At Step 404, the system executes Record Product Data on Blockchain, where the unique identifier, along with associated product metadata, is transmitted to the blockchain network through a smart contract interface. The blockchain ledger immutably stores this data as a new block entry, providing an unalterable reference record for future verification events.

At Step 405, the product is Shipped to Distributor. Upon shipment, the blockchain record may be updated with logistics information such as origin warehouse, shipping timestamp, and transport ID. This entry serves as proof of dispatch.

At Step 406, the product reaches a Logistics Checkpoint, where the Scan Tag at Logistics Checkpoint operation is performed. Here, a distribution agent or automated scanner captures the product's identifier to confirm receipt. Each scan event automatically generates a blockchain transaction confirming the product's movement and updating its custody status.

At Step 407, the system performs Update Blockchain Status in Transit, wherein the blockchain ledger is updated with location and transit details, including intermediary checkpoints. The distributed ledger thus maintains a tamper-proof trail of custody, ensuring supply chain transparency.

At Step 408, the product is Received at Retail Store, completing its logistics transfer. The retailer's receipt of the product is also logged on the blockchain, verifying authenticity and enabling traceable handover from manufacturer to retailer.

At Step 409, a Mobile Application Queries Blockchain Ledger to retrieve relevant details about the product's authenticity and status. The application interfaces with the blockchain via an API to confirm that the product identifier exists and remains active in the ledger.

At Step 410, the Consumer Scans Tag with Mobile Application. The consumer uses a smartphone app to scan the QR or NFC tag attached to the product. The app transmits the image and identifier data to the backend system, where the AI-based tamper detection module and authentication engine process the information.

At Step 411, the Display Product for Sale operation occurs at the retail level. The product is made available to consumers, with blockchain-based verification data optionally displayed at the point of sale, ensuring consumer trust and visibility into product provenance.

At Step 412, the retailer Scans Product and Updates Blockchain in Store, creating a new blockchain transaction entry that links the retail location and timestamp with the product's identifier. This establishes a verifiable retail checkpoint confirming that the product entered a legitimate point of sale.

At Step 413, the AI Analyzes Scan Pattern and Product Image. The AI-based tamper detection module receives the scanned image data and performs feature extraction using convolutional neural networks (CNNs) or equivalent models. It compares the scanned tag's visual and structural features against the registered reference image stored on the blockchain or linked off-chain database.

At Decision Step 414, the system determines whether Tampering or Counterfeit is Detected. If the AI analysis identifies anomalies such as misalignment, distortion, or duplication of identifiers, the product is flagged as potentially tampered. If no discrepancies are detected, the system proceeds with standard authentication steps.

If no tampering is detected, the process advances to Step 415, where the system Displays Authentic Product Information to the User. The mobile application retrieves verified details from the blockchain, such as manufacturer name, batch number, and origin, and displays them to the consumer with a confirmation message of authenticity.

At Step 416, the Consumer Proceeds to Purchase, completing the transaction for an authenticated product. The verified blockchain data assures the buyer of product genuineness and ownership traceability.

At Step 418, the Point of Sale System Scans Product, linking the sale to the specific identifier. The POS system validates the product against blockchain records one final time before completing the sale transaction.

At Step 419, the POS Updates Blockchain Status as Sold, triggering a smart contract that updates the product's blockchain record to reflect its sold status. This change prevents the same identifier from being reused in fraudulent sales.

At Step 420, the system Deactivates Tag post-sale. The product tag is marked inactive on the blockchain, ensuring that future scans will return a “sold or inactive” message, preventing post-sale reuse or counterfeit duplication.

At Step 421, any Scan Returns Sold or Inactive status, signaling to subsequent users that the product has already been authenticated and transferred to a final owner. This step effectively closes the product's lifecycle on the blockchain.

If the system determines at Step 414 that tampering or counterfeiting is detected, the process diverges to Step 417, where the AI Flags Alert and Records Incident on Blockchain. The system generates a tamper incident report including the product ID, timestamp, tamper confidence score, and geographic location. The report is written immutably to the blockchain and simultaneously triggers an alert to the manufacturer and supply chain administrators.

Once either the authentication or tamper-handling process concludes, the system finalizes the operation and transitions to the End state. At this stage, all product lifecycle events—including manufacturing, shipping, scanning, authentication, and sale—are recorded immutably on the blockchain. The blockchain ledger thus forms a complete digital audit trail for the product's origin, movement, verification, and ownership, providing transparency and preventing unauthorized duplication or manipulation.

The flowchart in FIG. 6 demonstrates how the invention achieves end-to-end authentication by merging AI-based visual analysis with blockchain-based data integrity. The integration of tamper detection, smart contract-based automation, and lifecycle event tracking ensures that authenticity is validated at every node in the supply chain. The system not only prevents counterfeit infiltration but also provides manufacturers and consumers with real-time trust verification through immutable blockchain records. Additionally, by deactivating tags post-sale and maintaining permanent incident logs, the invention ensures long-term product traceability, accountability, and auditability across global distribution networks.

While the exemplary embodiments of the present invention are described and illustrated herein, it will be appreciated that they are merely illustrative. It will be understood by those skilled in the art that various modifications in form and detail may be made therein without departing from or offending the spirit and scope of the invention as defined by the appended claims. Additionally, the invention illustratively disclosed herein suitably may be practiced in the absence of any element which is not specifically disclosed herein- and in particular embodiment specifically contemplated, is intended to be practiced in the absence of any element which is not specifically disclosed herein.

1. A system for product authentication using blockchain and artificial intelligence, comprising:
(a) a user interface module comprising a consumer mobile application and a retail point-of-sale (POS) terminal configured to capture a product identifier in the form of a QR code, barcode, or NFC tag associated with a product;
(b) an application gateway configured to receive the product identifier and related metadata from the user interface module through a secure communication network;
(c) an AI-based tamper detection module configured to analyze an image of the product identifier to detect tampering, counterfeiting, or alteration using one or more machine learning algorithms;
(d) an authentication engine configured to compare output from the AI-based tamper detection module with product registration data stored in a blockchain ledger;
(e) a blockchain network comprising a plurality of nodes maintaining an immutable record of product registration, ownership transfer, and verification events; and
(f) a notification and alert module configured to transmit verification results or tamper alerts to at least one of the consumer mobile application, manufacturer dashboard, or regulatory authority,
wherein the system authenticates a product throughout its lifecycle by verifying both physical label integrity and blockchain-based digital provenance.

2. A computer-implemented method for product authentication using blockchain and artificial intelligence, comprising the steps of:
(a) generating, by a manufacturer, a unique product identifier and associating the identifier with product metadata;
(b) registering, via a smart contract, the product identifier and metadata on a blockchain ledger;
(c) capturing, via a consumer device or POS terminal, an image or scan of the product identifier;
(d) transmitting the captured data to an AI-based tamper detection module through an application gateway;
(e) analyzing, by the AI-based tamper detection module, the captured data to identify visual inconsistencies or tampering features;
(f) retrieving, by an authentication engine, a reference record corresponding to the product identifier from the blockchain ledger;
(g) comparing the AI analysis results and blockchain record to determine authenticity;
(h) recording, on the blockchain, a verification event indicating authenticity or tampering; and
(i) notifying the consumer and manufacturer of the verification result,
wherein each verification event is immutably stored to enable end-to-end product lifecycle traceability.

3. The system of claim 1, wherein the AI-based tamper detection module utilizes convolutional neural networks (CNNs), generative adversarial networks (GANs), or transformer-based models to identify micro-pattern deviations in the scanned product identifier.

4. The system of claim 1, wherein the blockchain network employs smart contracts to automate registration, ownership transfer, tamper alert issuance, and archival of product records.

5. The system of claim 1, wherein the blockchain record comprises a block header, product metadata, AI tamper analysis data, transaction data, and hash linkages ensuring immutability.

6. The system of claim 1, wherein the notification and alert module triggers automated alerts to the manufacturer upon detection of counterfeit or tampered products, including geolocation and image data.

7. The system of claim 1, wherein the authentication engine maintains a synchronization interface between on-chain and off-chain databases, the off-chain database storing large image files, metadata, and analytical results linked via hash pointers.

8. The method of claim 2, further comprising retraining the AI tamper detection model using authenticated and tampered image datasets to enhance accuracy through a continuous feedback learning mechanism.

9. The method of claim 2, further comprising assigning ownership transfer tokens upon sale completion at the POS terminal and recording the transfer on the blockchain via an automated smart contract.

10. The method of claim 2, further comprising generating a tamper confidence score representing a numerical likelihood of label manipulation, wherein the product is classified as authentic or tampered based on a threshold comparison.

11. The method of claim 2, wherein the product metadata includes product ID, manufacturer ID, batch number, origin, and production date, and is stored as a hashed record on the blockchain.

12. The method of claim 2, wherein the notification step includes sending push alerts to a consumer device, dashboard notifications to the manufacturer, and automatic compliance alerts to regulators in case of counterfeit detection.

13. The method of claim 2, wherein the blockchain ledger is updated to reflect a product's lifecycle events comprising registration, distribution, retail verification, consumer ownership, and archival.

14. The system of claim 1, further comprising a manufacturer dashboard configured to display blockchain transactions, verification reports, and AI tamper detection statistics in real time.

15. The system of claim 1, wherein the AI-based tamper detection module and the authentication engine are deployed as microservices within a cloud-based infrastructure to support horizontal scalability and high throughput.

16. The system of claim 1, wherein the application gateway enforces security protocols including token-based authentication, end-to-end encryption, and digital signature validation for all data transmissions.

17. The system of claim 1, wherein the blockchain record of each product lifecycle event is digitally signed by the corresponding entity performing the event, thereby creating a verifiable chain of custody.

18. The method of claim 2, further comprising analyzing post-sale scans performed by consumers to detect re-use of identifiers or duplicate packaging instances.

19. The system of claim 1, wherein all modules collectively enable a tamper-proof, traceable, and self-learning authentication ecosystem capable of detecting, recording, and preventing counterfeit product distribution throughout the supply chain.
